(19) United States
(12) Patent Application Publication
(10) Pub. No.: US 2026/0175316 A1
(43) Pub. Date: Jun. 25, 2026

(54) EXTERNAL MOTOR ACTUATOR FOR AN X/Y STAGE

(71) Applicant: KLA Corporation, Milpitas, CA (US)

(72) Inventor: Aviv Balan, Mountain View, CA (US)

(21) Appl. No.: 18/990,086

(22) Filed: Dec. 20, 2024

(51) Int. Cl. B23K 15/00; B23K 15/08; B23K 37/04; H02K 41/02

(52) U.S. Cl. CPC B23K 15/0013; B23K 37/04; H02K 41/02; B23K 15/08

(57) ABSTRACT

A positioning system may use an external motor actuator to eliminate an on-board actuator of the x/y-axis stage by connecting to the x/y-axis stage via a beam. The beam may be connected to the motor actuator mounted on a base of the positioning system. The beam may be connected to an upper axis carriage by linear bearings, allowing the x/y-axis stage to move in a perpendicular direction as the x/y-axis stage follows the beam. The positioning system may be used in a processing system to x/y-axis scan the chuck under a processing head.

### TECHNICAL FIELD

The present disclosure generally relates to the field of semiconductor inspection and lithography systems, and, more particularly, to stage mechanisms for such inspection and lithography systems.

### BACKGROUND

High position accuracy is one important factor for wafer inspection and lithography tools. The future requirements for stage accuracy is predicted to be in the region of a few nanometers. For instance, an inspection tool may need to report the defect location within a few nanometers when defining very small care areas and reporting the defect location with respect to the wafer design files so that defects can be further analyzed. Likewise, position resolution in photolithography tools is also increasing.

An upper axis of a stage may move by a motor. The motor on the upper axis may add mass and generate heat and require cables. The heat must be removed or cooled to reduce an impact on accuracy and stability due to deformation. Therefore, it would be advantageous to provide a device, system, and method that cures the shortcomings described above.

### SUMMARY

A positioning system is described, in accordance with one or more embodiments of the present disclosure. The positioning system may include: a base; a pair of x-axis linear motors; a pair of y-axis linear motors, wherein the pair of y-axis linear motors are perpendicular to the pair of x-axis linear motors; an x-axis stage, wherein the pair of x-axis linear motors are coupled between the x-axis stage and the base, wherein the pair of x-axis linear motors are coupled to opposing ends of the x-axis stage by which the x-axis stage is configured to translate along an x-axis; a y-axis stage, wherein the pair of y-axis linear motors are coupled between the y-axis stage and the base, wherein the pair of y-axis linear motors are coupled to opposing ends of the y-axis stage by which the y-axis stage is configured to translate along a y-axis, wherein the x-axis stage and the y-axis stage are piled; and an x/y-axis stage, wherein the x/y-axis stage is coupled in parallel with the x-axis stage and the y-axis stage, wherein the x/y-axis stage is configured to follow translation of the x-axis stage along the x-axis and translation of the y-axis stage along the y-axis, wherein the x/y-axis stage includes: an x-axis carriage; a y-axis carriage, wherein the x-axis carriage and the y-axis carriage couple the x/y-axis stage to the x-axis stage and the y-axis stage, respectively; and a chuck.

A processing system is described, in accordance with one or more embodiments of the present disclosure. The processing system may include: a positioning system including: a base; a pair of x-axis linear motors; a pair of y-axis linear motors, wherein the pair of y-axis linear motors are perpendicular to the pair of x-axis linear motors; an x-axis stage, wherein the pair of x-axis linear motors are coupled between the x-axis stage and the base, wherein the pair of x-axis linear motors are coupled to opposing ends of the x-axis stage by which the x-axis stage is configured to translate along an x-axis; a y-axis stage, wherein the pair of y-axis linear motors are coupled between the y-axis stage and the base, wherein the pair of y-axis linear motors are coupled to opposing ends of the y-axis stage by which the y-axis stage is configured to translate along a y-axis, wherein the x-axis stage and the y-axis stage are piled; and an x/y-axis stage, wherein the x/y-axis stage is coupled in parallel with the x-axis stage and the y-axis stage, wherein the x/y-axis stage is configured to follow translation of the x-axis stage along the x-axis and translation of the y-axis stage along the y-axis, wherein the x/y-axis stage includes: an x-axis carriage; a y-axis carriage, wherein the x-axis carriage and the y-axis carriage couple the x/y-axis stage to the x-axis stage and the y-axis stage, respectively; and a chuck, wherein the chuck is configured to hold a sample; and a processing head, wherein the positioning system is configured to x/y-axis scan the chuck with the sample under the processing head.

A method is described, in accordance with one or more embodiments of the present disclosure. The method may include: holding a sample by a chuck of an x/y-axis stage of a positioning system, wherein the positioning system includes: a base; a pair of x-axis linear motors; a pair of y-axis linear motors, wherein the pair of y-axis linear motors are perpendicular to the pair of x-axis linear motors; an x-axis stage, wherein the pair of x-axis linear motors are coupled between the x-axis stage and the base, wherein the pair of x-axis linear motors are coupled to opposing ends of the x-axis stage by which the x-axis stage is configured to translate along an x-axis; a y-axis stage, wherein the pair of y-axis linear motors are coupled between the y-axis stage and the base, wherein the pair of y-axis linear motors are coupled to opposing ends of the y-axis stage by which the y-axis stage is configured to translate along a y-axis, wherein the x-axis stage and the y-axis stage are piled; and the x/y-axis stage, wherein the x/y-axis stage is coupled in parallel with the x-axis stage and the y-axis stage, wherein the x/y-axis stage is configured to follow translation of the x-axis stage along the x-axis and translation of the y-axis stage along the y-axis, wherein the x/y-axis stage includes: an x-axis carriage; a y-axis carriage, wherein the x-axis carriage and the y-axis carriage couple the x/y-axis stage to the x-axis stage and the y-axis stage, respectively; and the chuck; and x/y-axis scanning the chuck with the sample under a processing head.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the description and drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1A depicts a perspective view of a positioning system, in accordance with one or more embodiments of the present disclosure.

FIG. 1B depicts a perspective view of the positioning system with an x/y-axis stage following an x-axis stage of the positioning system, in accordance with one or more embodiments of the present disclosure.

FIG. 1C depicts a perspective view of the positioning system with the x/y-axis stage following a y-axis stage of the positioning system, in accordance with one or more embodiments of the present disclosure.

FIG. 2 depicts a cross-section view of an optical system including the positioning system, in accordance with one or more embodiments of the present disclosure.

FIG. 3 depicts a flow diagram of a method, in accordance with one or more embodiments of the present disclosure.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure. Reference will now be made in detail to the subject matter disclosed, which is illustrated in the accompanying drawings.

Embodiments of the present disclosure are directed to an external motor actuator for an x/y-axis stage. A positioning system may use an external motor actuator to eliminate an on-board actuator of the x/y-axis stage by connecting to the x/y-axis stage via a beam. The beam may be connected to the motor actuator mounted on a base of the positioning system. The beam may be connected to an upper axis carriage by linear bearings, allowing the x/y-axis stage to move in a perpendicular direction as the x/y-axis stage follows the beam. The positioning system may be used in a processing system to x/y-axis scan the chuck under a processing head.

U.S. Pat. No. 8,517,363B2, titled “XY stage device, semiconductor inspection apparatus, and semiconductor exposure apparatus”; U.S. Pat. No. 8,575,792B2, titled “Motorized stage”; U.S. Pat. No. 8,773,227B2, titled “Method for fabricating an electromagnetic actuator, an electromagnetic actuator, and a charged particle device comprising the same”; U.S. Pat. No. 9,529,280B2, titled “Stage apparatus for semiconductor inspection and lithography systems”; U.S. Pat. No. 11,209,373B2, titled “Six degree of freedom workpiece stage”; U.S. Pat. No. 11,637,030B2, titled “Multi-stage, multi-zone substrate positioning systems”; U.S. Patent Publication Number US20090153824A1, titled “Multiple chuck scanning stage”; U.S. Patent Publication Number US20150280539A1, titled “Primary part for a linear motor, a linear motor comprising the same, and method for manufacturing such primary part”; are each incorporated herein by reference in the entirety.

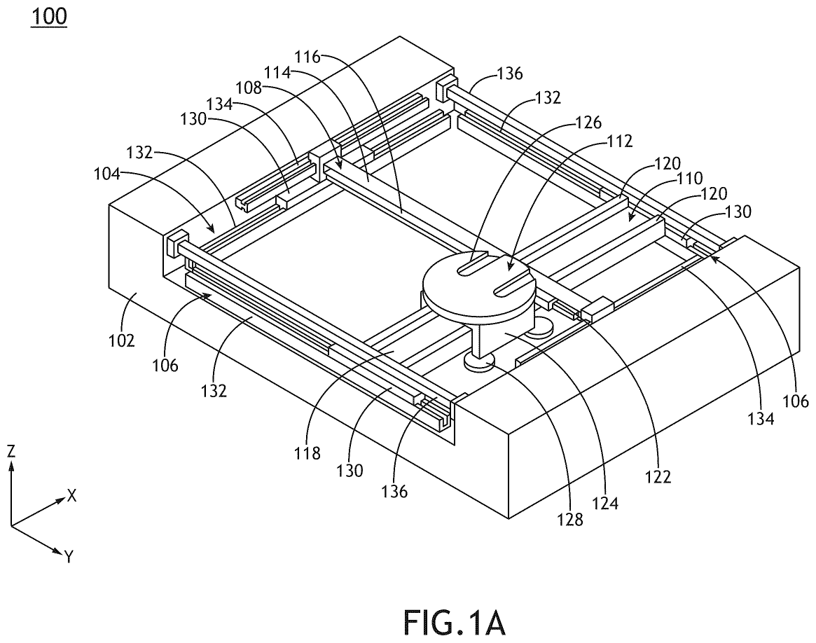

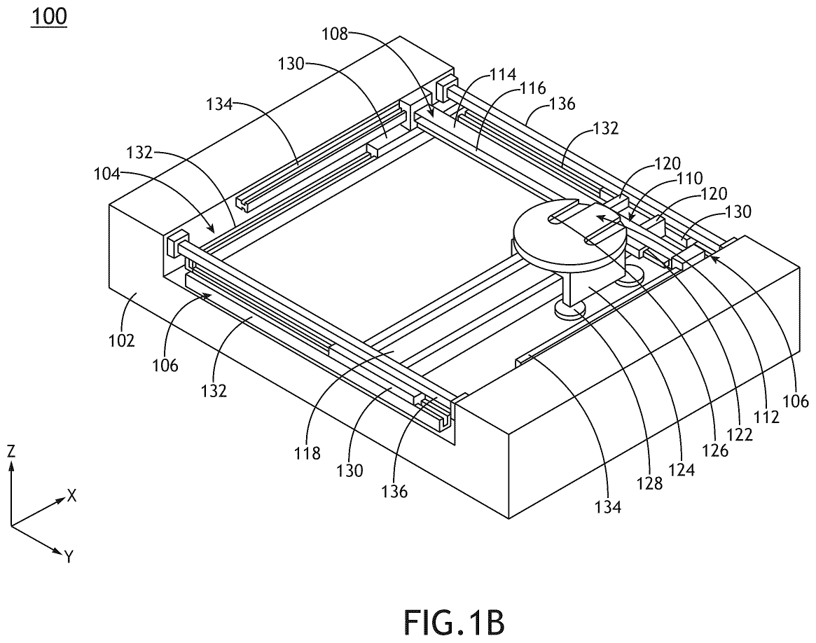

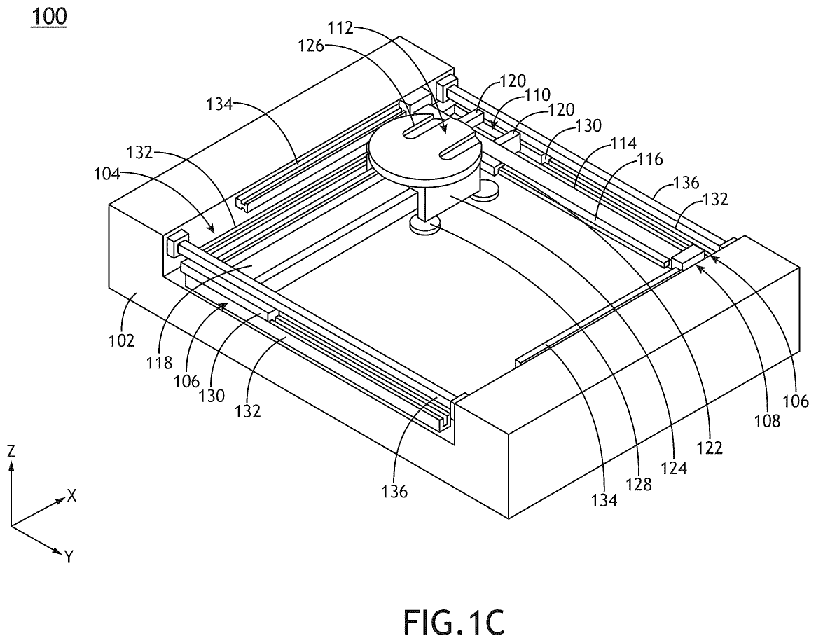

FIGS. 1A-1C depict a positioning system 100, in accordance with one or more embodiments of the present disclosure. The positioning system 100 may be an x-y positioning system. The positioning system 100 may also be configured to perform z-positioning and/or Θx, Θy, and/or Θz-positioning. The positioning system 100 may include one or more components, such as a base 102, x-axis linear motors 104, y-axis linear motors 106, an x-axis stage 108, a y-axis stage 110, an x/y-axis stage 112, x-axis encoders 134, and/or y-axis encoders 136.

The base 102 may be formed from a granite material onto which any of the various components of the positioning system 100 may be attached.

The positioning system 100 may include a pair of the x-axis linear motors 104 and a pair of the y-axis linear motors 106. The x-axis linear motors 104 and the y-axis linear motors 106 may extend along the x-axis and the y-axis, respectively. The y-axis linear motors 106 may be perpendicular to the x-axis linear motors 104. The x-axis linear motors 104 may be arranged in parallel and coupled to opposing ends of the x-axis stage 108 by which the x-axis stage 108 is configured to translate along the x-axis. Similarly, the y-axis linear motors 106 may be arranged in parallel and coupled to opposing ends of the y-axis stage 110 by which the y-axis stage 110 is configured to translate along the y-axis. The y-axis linear motors 106 may translate the y-axis stage 110 independently of the x-axis linear motors 104 translating the x-axis stage 108. In this regard, the axial prefix of the x-axis linear motors 104 and the y-axis linear motors may be defined based on the length and motion along the respective axes.

The x-axis linear motors 104 and the y-axis linear motors 106 may be any suitable linear actuators, such as, but not limited to, magnetic track actuators, leadscrew-based linear actuators, solenoids, pneumatic linear actuators, or the like. For example, the x-axis linear motors 104 and the y-axis linear motors 106 may be linear magnetic tracks. The x-axis linear motors 104 and the y-axis linear motors 106 may include the coil units 130 and the magnetic tracks 132. The magnetic tracks 132 may be affixed to the base 102. The magnetic tracks 132 of the x-axis linear motors 104 and the y-axis linear motors 106 may be aligned along the x-axis and the y-axis respectively. The coil units 130 may be configured to linearly translate along the magnetic tracks 132. The magnetic tracks 132 may include a linear array of magnets arranged to form a channel. The coil units 130 may magnetically couple to the magnets within the channel. The coil units 130 may carry a current by which the x-axis linear motors 104 and the y-axis linear motors 106 are configured to linearly translate the x-axis stage 108 and the y-axis stage 110, respectively.

The x-axis linear motors 104 and the y-axis linear motors 106 may be external motors. For example, the x-axis linear motors 104 and the y-axis linear motors 106 may be external to and separated from the x/y-axis stage 112 by the x-axis stage 108 and the y-axis stage 110. In this regard, the heat and/or electromagnetic fields produced by the x-axis linear motors 104 and the y-axis linear motors 106 may be separated from the x/y-axis stage 112 via the x-axis stage 108 and the y-axis stage 110, respectively. Similarly, a weight of the x/y-axis stage 112 may be reduced by separating the x-axis linear motors 104 and the y-axis linear motors 106 from the x/y-axis stage 112, which may allow for more precise and/or rapid positioning of the x/y-axis stage 112.

The x-axis stage 108 and the y-axis stage 110 may be perpendicular stages. In this regard, the x-axis stage 108 may be perpendicular to the y-axis stage 110.

The x-axis stage 108 and the y-axis stage 110 may be linear stages. The x-axis stage 108 and the y-axis stage 110 may be configured to linearly translate along the x-axis and the y-axis, respectively. The x-axis linear motors 104 may couple between the base 102 and the x-axis stage 108. Similarly, the y-axis linear motors 106 may couple between the base 102 and the y-axis stage 110. The x-axis linear motors 104 and the y-axis linear motors 106 may be configured to translate the x-axis stage 108 and the y-axis stage 110, respectively, relative to the base 102 along the x-axis and the y-axis, respectively. The x-axis linear motors 104 and the y-axis linear motors 106 may form prismatic joints, thereby causing the x-axis stage 108 and the y-axis stage 110 to linearly translate along the x-axis and the y-axis, respectively. The prismatic joints may also prevent the x-axis stage 108 and the y-axis stage 110 from any translation and/or rotation other than the translation along the x-axis and the y-axis, respectively.

The x-axis stage 108 and the y-axis stage 110 may include one or more components. For example, the x-axis stage 108 may include an x-axis crossmember 114 and/or x-axis rails 116. The x-axis crossmember 114 and the x-axis rails 116 may be affixed together. By way of another example, the y-axis stage 110 may include a y-axis crossmember 118 and/or y-axis rails 120. The y-axis crossmember 118 and the y-axis rails 120 may be affixed together. Each of the respective components of the x-axis stage 108 and the y-axis stage 110 may follow the respective motions along the x-axis and the y-axis. The term follow or follows may be used in the kinematic sense of a follower moving in response to motion of a cam.

The x-axis crossmember 114 and the y-axis crossmember 118 may span between and couple to the x-axis linear motors 104 and the y-axis linear motors 106, respectively. For example, the coil units 130 of the x-axis linear motors 104 and the y-axis linear motors 106 may couple to opposing ends of the x-axis crossmember 114 and to opposing ends of the y-axis crossmember 118, respectively.

The x-axis crossmember 114 and/or the y-axis crossmember 118 may be any suitable shape, such as, but not limited to, a beam, a plate, or the like. For example, the x-axis crossmember 114 may be a beam and the y-axis crossmember 118 may be a plate, although this is not intended to be limiting. The beam may refer to a square-tube shaped beam. The plate may be flat along the x/y-axis plane.

The x-axis rails 116 and the y-axis rails 120 may couple to the x-axis crossmember 114 and the y-axis crossmember 118, respectively. The x-axis rails 116 and the y-axis rails 120 may couple to any face of the x-axis crossmember 114 and the y-axis crossmember 118, respectively. For example, the x-axis rails 116 may couple to a side-face of the x-axis crossmember 114 and the y-axis rails 120 may couple to a top-face of the y-axis crossmember 118. The x-axis rails 116 may couple between the x-axis crossmember 114 and the x/y-axis stage 112. Similarly, the y-axis rails 120 may couple between the y-axis crossmember 118 and the x/y-axis stage 112. The x-axis rails 116 and the y-axis rails 120 may extend along a portion of the length of the x-axis crossmember 114 and the y-axis crossmember 118, respectively, without interfering with the translation of the x-axis linear motors 104 and the y-axis linear motors 106, respectively. The x-axis stage 108 and the y-axis stage 110 may include any number of the x-axis rails 116 and the y-axis rails 120, respectively. For example, the x-axis stage 108 may include a pair of the x-axis rails 116 and the y-axis stage 110 may include one of the y-axis rails 120, although this is not intended to be limiting.

The length of the x-axis crossmember 114 and the x-axis rails 116 may extend along the y-axis between the x-axis linear motors 104 while translating along the x-axis. Similarly, the length of the y-axis crossmember 118 and the y-axis rails 120 may extend along the x-axis between the y-axis linear motors 106 while translating along the y-axis. The axial motions of the x-axis crossmember 114, the x-axis rails 116, the y-axis crossmember 118, and/or the y-axis rails 120 may be perpendicular to the orientation of the lengths. In this regard, the axial prefix (e.g., x-axis, y-axis) of the x-axis crossmember 114, the x-axis rails 116, the y-axis crossmember 118, and/or the y-axis rails 120 may be defined based on the translation relative to the base 102 and not based on the orientation of the length.

The x-axis stage 108 and the y-axis stage 110 may be piled. Translation along the x-axis stage 108 and the y-axis stage 110 may not be on a same level but on different levels where the x-axis stage 108 and the y-axis stage 110 are piled. For example, the x-axis stage 108 and the y-axis stage 110 may be piled with the x-axis stage 108 disposed above the y-axis stage 110, although this is not intended to be limiting. It is further contemplated that the x-axis stage 108 may be disposed below the y-axis stage 110 with appropriate modifications to the couplings with the x-axis linear motors 104, the y-axis linear motors 106, and/or the x/y-axis stage 112.

The x-axis stage 108 and the y-axis stage 110 may also be referred to as cross-slides, moving guideways, moving bridges, and/or sliding pairs along which the x/y-axis stage 112 is moved. The x/y-axis stage 112 may be configured to linearly translate along both the x-axis and the y-axis. The x/y-axis stage 112 may translate along the x-axis with the x-axis stage 108 when the x-axis linear motors 104 are engaged and/or may translate along the y-axis with the y-axis stage 110 when the y-axis linear motors 106 are engaged. The x/y-axis stage 112 may also be simultaneously translated along the x-axis with the x-axis stage 108 and along the y-axis with the y-axis stage 110 when the x-axis linear motors 104 and the y-axis linear motors 106 are simultaneously engaged. The x/y-axis stage 112 may couple to both the x-axis stage 108 and the y-axis stage 110. The x/y-axis stage 112 may couple in parallel with the x-axis stage 108 and the y-axis stage 110. The x/y-axis stage 112 may follow the translation of the x-axis stage 108 along the x-axis and may follow the translation of the y-axis stage 110 along the y-axis such that the x/y-axis stage 112 is configured to translate along both the x-axis and the y-axis. The x-axis linear motors 104 via the x-axis stage 108 and the y-axis linear motors 106 via the y-axis stage 110 may cause the x/y-axis stage 112 to translate along the x-axis and the y-axis, respectively.

The x/y-axis stage 112 may include one or more components, such as, but not limited to, an x-axis carriage 122, a y-axis carriage 124, a chuck 126, bearings 128, and the like. The x-axis carriage 122, the y-axis carriage 124, the chuck 126, and the bearings 128 may be affixed together. Each of the components of the x/y-axis stage 112 may follow the translation of the x/y-axis stage 112 along the x-axis and the y-axis.

The x-axis carriage 122 and the y-axis carriage 124 may couple the x/y-axis stage 112 to the x-axis stage 108 and the y-axis stage 110, respectively. The x-axis carriage 122 may cause the x/y-axis stage 112 to follow the x-axis stage 108 along the x-axis. Similarly, the y-axis carriage 124 may cause the x/y-axis stage 112 to follow the y-axis stage 110 along the y-axis. For example, the x-axis carriage 122 and the y-axis carriage 124 may push/pull the x/y-axis stage 112 along the x-axis and the y-axis, respectively, thereby causing the x/y-axis stage 112 to follow the x-axis stage 108 and the y-axis stage 110, respectively.

The x-axis carriage 122 and the y-axis carriage 124 may include any suitable coupling with the x-axis rails 116 and the y-axis rails 120, respectively, such as, but not limited to, linear bearings, air bearings, mechanical carriages, or the like.

The x/y-axis stage 112 may couple with the x-axis stage 108 and the y-axis stage 110 in a manner which does not bind the y-axis stage 110 when following the x-axis stage 108, and vice-versa. The x-axis carriage 122 and the x-axis rails 116 may form a prismatic joint along which the x/y-axis stage 112 is configured to translate. Similarly, the y-axis carriage 124 and the y-axis rails 120 may form a prismatic joint along which the x/y-axis stage 112 is configured to translate. The x-axis carriage 122 and the y-axis carriage 124 may couple to the x-axis rails 116 and the y-axis rails 120, respectively, thereby forming the prismatic joints. The y-axis carriage 124 may configure the x/y-axis stage 112 to translate along the length of the y-axis rails 120 as the x/y-axis stage 112 follows the translation of the x-axis stage 108 along the x-axis via the x-axis carriage 122. Similarly, the x-axis carriage 122 may configure the x/y-axis stage 112 to translate along the length of the x-axis rails 116 as the x/y-axis stage 112 follows the translation of the y-axis stage 110 along the y-axis via the y-axis carriage 124. In this regard, the axial prefix of the x-axis carriage 122 and the y-axis carriage 124 may be defined based on the coupling with the x-axis stage 108 and the y-axis stage 110, respectively, and not on the translation along the x-axis rails 116 and the y-axis rails 120.

The y-axis carriage 124 may be a main carriage and the x-axis carriage 122 may be a secondary carriage. For example, the y-axis carriage 124 may be larger than the x-axis carriage 122 and/or bear a weight of the x/y-axis stage 112.

The chuck 126 may be a sample holder. The chuck 126 may be disposed above the x-axis carriage 122, the y-axis carriage 124, and/or the bearings 128. The chuck 126 may be coupled to either of the x-axis carriage 122 or the y-axis carriage 124. For example, the chuck 126 may be coupled to y-axis carriage 124.

In embodiments, the chuck 126 may be configured to translate and/or rotate relative to the x-axis carriage 122 and/or the y-axis carriage 124. For example, the chuck 126 may be configured to translate along the x-axis, the y-axis, and/or the z-axis relative to the y-axis carriage 124 and/or rotate about the Θx-axis, Θy-axis, and/or Θz-axis axis relative to the y-axis carriage 124. The translation and/or rotation of the chuck 126 relative to the y-axis carriage 124 may provide for fine positioning of the chuck 126 and a sample held by the chuck 126 relative to the base 102. In this regard, the chuck 126 may also be referred to as a sub-stage or a secondary stage of the x/y-axis stage 112. It is further contemplated that the chuck 126 may be affixed to the x-axis carriage 122 and/or the y-axis carriage 124 and may not translate and/or rotate relative thereto.

The bearings 128 may be disposed below the x-axis carriage 122, the y-axis carriage 124, and/or the chuck 126. The bearings 128 may be considered a horizontal bearing, in that the bearings 128 may constrain the x/y-axis stage 112 to the base 102 in the z-axis while permitting translation along the x-axis and the y-axis. The bearings 128 may couple between the x/y-axis stage 112 and the base 102. For example, a portion of the weight of the x-axis stage 108, the y-axis stage 110, and/or the x/y-axis stage 112 may be borne through the bearings 128 to the base 102. The bearings 128 may be beneficial to smooth the translation of the x-axis stage 108 and/or the x/y-axis stage 112 along the x-axis and/or to smooth the translation of the y-axis stage 110 and/or the x/y-axis stage 112 along the y-axis. The bearings 128 may be affixed to a bottom portion of the x/y-axis stage 112. For example, the bearings 128 may be affixed to a bottom face of the y-axis carriage 124. The positioning system 100 may include any number of the bearings 128. For example, the positioning system 100 is depicted with four of the bearings 128, although this is not intended as a limitation of the present disclosure. The bearings 128 may include any type of bearing, such as, but not limited to, air bearings, mechanical bearings, magnetic levitation bearings, or the like.

Although the x/y-axis stage 112 is described as including the bearings 128, this is not intended as a limitation of the present disclosure. The bearings 128 may be optional within the x/y-axis stage 112. It is contemplated that the weight of the x/y-axis stage 112 may be borne to the base 102 through the x-axis linear motors 104, the y-axis linear motors 106, the x-axis stage 108, and/or the y-axis stage 110. In these examples, the x-axis linear motors 104, the y-axis linear motors 106, the x-axis stage 108, and/or the y-axis stage 110 may include bearings which couple to the base 102. However, the bearings 128 may be beneficial to prevent deflection of the x/y-axis stage 112 relative to the base 102 in the z-axis.

The x-axis encoders 134 and the y-axis encoders 136 may be configured to sense an x-axis position and a y-axis position, respectively, of the x/y-axis stage 112. The x-axis encoders 134 and the y-axis encoders 136 may be any suitable encoder for sensing the positions, such as, but not limited to, a sensor, transducer, or the like. The sensed positions may be either incremental or absolute. The x-axis encoders 134 and the y-axis encoders 136 may be positioned along the y-axis and the x-axis respectively. The x-axis encoders 134 and the y-axis encoders 136 may couple to any component of the positioning system 100 for sensing the positions of the x/y-axis stage 112. For example, the x-axis encoders 134 may couple to the x-axis linear motors 104 and/or the x-axis stage 108. By way of another example, the y-axis encoders 136 may couple to the y-axis linear motors 106 and/or the y-axis stage 110.

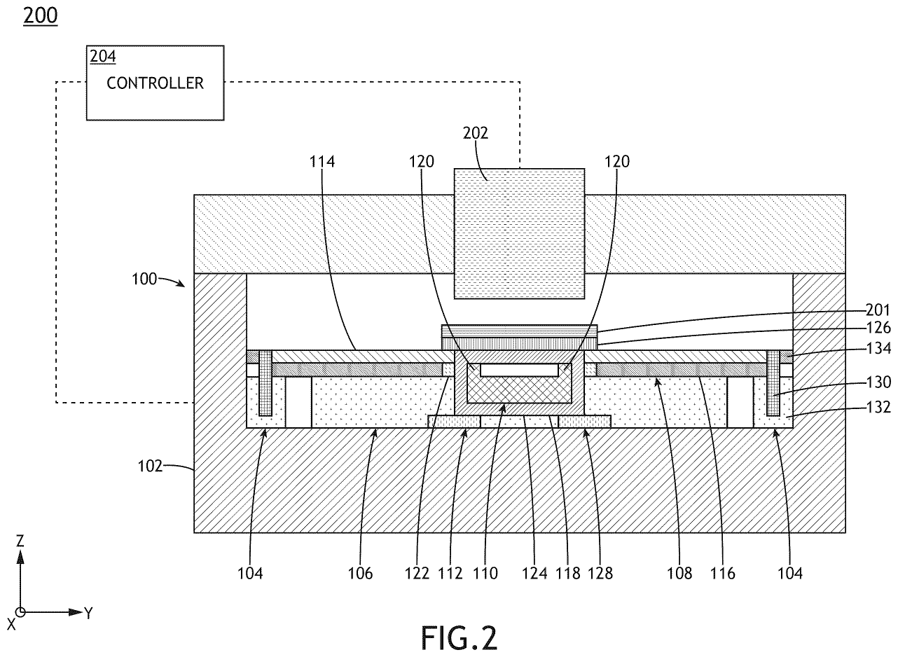

FIG. 2 depicts a processing system 200, in accordance with one or more embodiments of the present disclosure. The processing system 200 may be an exposure, metrology, inspection tool, or the like that requires precision positioning. The processing system 200 may be configured to process a sample 201. The processing system 200 may include one or more components, such as, but not limited to the positioning system 100, a processing head 202, a controller 204, or the like.

The chuck 126 may be configured to hold the sample 201. The chuck 126 may be configured to hold the sample 201 through vacuum, magnetic or electrostatic force.

The positioning system 100 may be configured to x/y-axis scan the chuck 126 with the sample 201 under the processing head 202. X/y-axis scanning may refer to moving the sample 201 in the x-axis and the y-axis. For example, the x/y-axis scanning may include performing a serpentine scan, a step-and-repeat scan, a continuous scan, or the like.

The processing head 202 may be configured to facilitate any type of substrate processing that utilizes x/y-axis scanning. Examples of suitable processing include metrology and inspection, exposure of resists to optical or charged particle (e.g., electron beam) radiation, or the like. The processing head 202 may be configured to direct a beam at the sample 201. The beam may be a photon, ion, or electron beam. The processing head 202 may include any suitable number and type of heads (or inspection or exposure system) for directing one or more beams towards the sample 201. For example, the processing head 202 may take the form of an optics column, electron-beam column, x-ray beam column, or the like. In the case of metrology or inspection, the processing head 202 may include an optical column coupled to a detector or a source of radiation or both. Such optical columns may be used for mask inspection, wafer inspection and the like. The source of radiation may be a narrow-band source, such as a laser or a broadband source. In some applications, such as mask writing, the optical column may include a reticle with a mask pattern. Radiation may be projected through the reticle onto layers of resist formed on the sample 201. The processing head 202 may include an electron beam column, as in a scanning electron microscope (SEM). The processing head 202 may include a cantilever probe, as in a scanning probe microscope such as an atomic force microscope (AFM) or scanning tunneling microscope (STM). The processing head 202 may include electron beam columns for electron beam writing, to perform patterned exposure of resists on the sample 201.

The controller 204 may be communicatively coupled with the positioning system 100. For example, the controller 204 may be communicatively coupled with the x-axis linear motors 104, the y-axis linear motors 106, the x-axis encoders 134, and/or the y-axis encoders 136. The controller 204 may be a stage controller for moving the positioning system 100 in both the x-axis and the y-axis. The controller 204 may use the positions sensed by the x-axis encoders 134 and/or the y-axis encoders 136 as feedback for controlling the x-axis linear motors 104 and the y-axis linear motors 106. Thus, the controller 204 may cause the positioning system 100 to x/y-axis scan the chuck 126 with the sample 201 under the processing head 202.

The controller 204 may also be communicatively coupled with the processing head 202. The controller 204 may cause the processing head 202 to capture signals of the sample 201 as the controller 204 causes the positioning system 100 to x/y-axis scan the chuck 126 with the sample 201 under the processing head 202. The controller 204 may also receive the signals. The signals captured by the processing head 202 may be processed by the controller 204 to perform inspection and/or metrology of the sample.

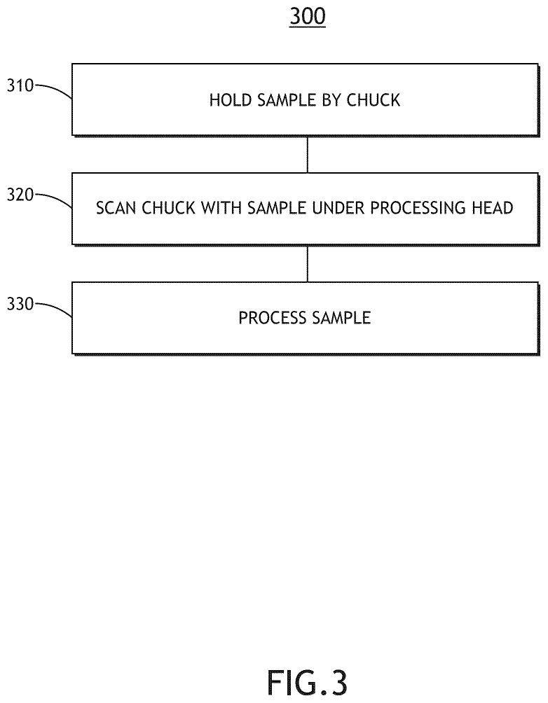

FIG. 3 depicts a flow diagram of a method 300, in accordance with one or more embodiments of the present disclosure. The method 300 provides a means for controlling the positioning system 100 and/or the processing system 200. The embodiments and the enabling technologies described previously herein in the context of the positioning system 100 and/or the processing system 200 should be interpreted to extend to the method. It is further noted, however, that the method 300 is not limited to the architecture of the positioning system 100 and/or the processing system 200.

In a step 310, a sample may be held by a chuck. For example, the sample 201 may be held by the chuck 126 of the x/y-axis stage 112.

In a step 320, a controller may cause a positioning system to x/y-axis scan the chuck with the sample under a processing head. For example, the controller 204 may cause the positioning system 100 to x/y-axis scan the chuck 126 with the sample 201 under the processing head 202. The controller 204 may cause the positioning system 100 to x/y-axis scan the chuck 126 by translating the x-axis stage 108 and the x/y-axis stage 112 along the x-axis via the x-axis linear motors 104 and/or by translating the y-axis stage 110 and the x/y-axis stage 112 along the y-axis via the y-axis linear motors 106.

In a step 330, the controller may cause the processing head to process the sample. For example, the controller 204 may cause the processing head 202 to process the sample 201.

Referring generally again to the figures. Although the term x-axis, y-axis, and z-axis are used in the present disclosure, this is not intended as a limitation of the present disclosure. Such axes may be switch with any of the others of the x-axis, y-axis, and z-axis, so long as the x-axis, y-axis, and z-axis are each perpendicular to each other.

The term “sample” may include to a substrate formed of a semiconductor or non-semiconductor material (e.g., thin filmed glass, or the like), a reticle, masks for photolithography, or the like. For example, a semiconductor or non-semiconductor material may include, but is not limited to, monocrystalline silicon, gallium arsenide, indium phosphide, or a glass material. A substrate may include one or more layers. For example, such layers may include, but are not limited to, a resist (including a photoresist), a dielectric material, a conductive material, and a semiconductive material. Many different types of such layers are known in the art, and the term sample as used herein is intended to encompass a substrate on which all types of such layers may be formed. One or more layers formed on a substrate may be patterned or un-patterned. For example, a substrate may include a plurality of dies, each having repeatable patterned features. Formation and processing of such layers of material may ultimately result in completed devices. Many different types of devices may be formed on a substrate, and the term substrate as used herein is intended to encompass a substrate on which any type of device known in the art is being fabricated. Further, for the purposes of the present disclosure, the term substrate and wafer should be interpreted as interchangeable. In addition, for the purposes of the present disclosure, the terms patterning device, mask and reticle should be interpreted as interchangeable.

A controller may include one or more controllers housed in a common housing or within multiple housings. In this way, any controller or combination of controllers may be separately packaged as a module suitable for integration into a system. Further, the controllers may analyze data received from detectors and feed the data to additional components within the system or external to the system.

The controller may include one or more processors configured to execute program instructions maintained on a memory medium, causing the controller to perform any of the various methods.

The one or more processors may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors may include any device configured to execute algorithms and/or instructions (e.g., program instructions stored in memory). In one embodiment, the one or more processors may be embodied as a desktop computer, mainframe computer system, workstation, image computer, parallel processor, networked computer, or any other computer system configured to execute a program configured to operate or operate in conjunction with the systems, as described throughout the present disclosure.

The memory medium may include any storage medium known in the art suitable for storing program instructions executable by the associated one or more processors. For example, the memory medium may include a non-transitory memory medium. By way of another example, the memory medium may include, but is not limited to, a read-only memory (ROM), a random-access memory (RAM), a magnetic or optical memory device (e.g., disk), a magnetic tape, a solid-state drive and the like. It is further noted that memory medium may be housed in a common controller housing with the one or more processors. In one embodiment, the memory medium may be located remotely with respect to the physical location of the one or more processors and controller. For instance, the one or more processors of controller may access a remote memory (e.g., server), accessible through a network (e.g., internet, intranet and the like).

It is further contemplated that each of the embodiments of the methods described above may include any other step(s) of any other method(s) described herein. In addition, each of the embodiments of the method described above may be performed by any of the systems described herein.

In the case of a control algorithm, one or more program instructions or methods may be configured to operate via proportional control, feedback control, feedforward control, integral control, proportional-derivative (PD) control, proportional-integral (PI) control, proportional-integral-derivative (PID) control, or the like.

It is noted herein that the one or more components of the system may be communicatively coupled to the various other components of system in any manner known in the art. For example, the one or more processors may be communicatively coupled to each other and other components via a wireline (e.g., copper wire, fiber optic cable, and the like) or wireless connection (e.g., RF coupling, IR coupling, WiMax, Bluetooth, 3G, 4G, 4G LTE, 5G, and the like). By way of another example, the controller may be communicatively coupled to one or more components of the system via any wireline or wireless connection known in the art.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mixable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A positioning system comprising:
a base;
a pair of x-axis linear motors;
a pair of y-axis linear motors, wherein the pair of y-axis linear motors are perpendicular to the pair of x-axis linear motors;
an x-axis stage, wherein the pair of x-axis linear motors are coupled between the x-axis stage and the base, wherein the pair of x-axis linear motors are coupled to opposing ends of the x-axis stage by which the x-axis stage is configured to translate along an x-axis;
a y-axis stage, wherein the pair of y-axis linear motors are coupled between the y-axis stage and the base, wherein the pair of y-axis linear motors are coupled to opposing ends of the y-axis stage by which the y-axis stage is configured to translate along a y-axis, wherein the x-axis stage and the y-axis stage are piled; and
an x/y-axis stage, wherein the x/y-axis stage is coupled in parallel with the x-axis stage and the y-axis stage, wherein the x/y-axis stage is configured to follow translation of the x-axis stage along the x-axis and translation of the y-axis stage along the y-axis, wherein the x/y-axis stage comprises:
an x-axis carriage;
a y-axis carriage, wherein the x-axis carriage and the y-axis carriage couple the x/y-axis stage to the x-axis stage and the y-axis stage, respectively; and
a chuck.

2. The positioning system of claim 1, wherein the pair of y-axis linear motors are configured to translate the y-axis stage independently of the pair of x-axis linear motors translating the x-axis stage.

3. The positioning system of claim 1, wherein the pair of x-axis linear motors and the pair of y-axis linear motors are separated from the x/y-axis stage by the x-axis stage and the y-axis stage, respectively.

4. The positioning system of claim 1, wherein the pair of x-axis linear motors and the pair of y-axis linear motors are magnetic track actuators, wherein the magnetic track actuators comprise magnetic tracks and coil units, wherein the magnetic tracks affixed to the base, wherein the coil units of the pair of x-axis linear motors are affixed to the x-axis stage, wherein the coil units of the pair of y-axis linear motors are affixed to the y-axis stage.

5. The positioning system of claim 1, wherein the x-axis stage comprises an x-axis crossmember and one or more x-axis rails, wherein the x-axis crossmember spans between and couples to the pair of x-axis linear motors, wherein the one or more x-axis rails couple between the x-axis crossmember and the x/y-axis stage, wherein the x-axis carriage couples to the one or more x-axis rails,
wherein the y-axis stage comprises a y-axis crossmember and one or more y-axis rails, wherein the y-axis crossmember spans between and couples to the pair of y-axis linear motors, wherein the one or more y-axis rails couple between the x-axis crossmember and the x/y-axis stage, wherein the y-axis carriage couples to the one or more y-axis rails.

6. The positioning system of claim 5, wherein the y-axis carriage configures the x/y-axis stage to translate along the one or more y-axis rails as the x/y-axis stage follows the translation of the x-axis stage along the x-axis;
wherein the x-axis carriage configures the x/y-axis stage to translate along the one or more x-axis rails as the x/y-axis stage follows the translation of the y-axis stage along the y-axis.

7. The positioning system of claim 5, wherein the x-axis crossmember is a beam and the y-axis crossmember is a plate.

8. The positioning system of claim 7, wherein the one or more x-axis rails is one x-axis rail, wherein the one x-axis rail is coupled to a side-face of the x-axis crossmember;
wherein the one or more y-axis rails is two y-axis rails, wherein the two y-axis rails are coupled to a top-face of the y-axis crossmember.

9. The positioning system of claim 1, wherein the x-axis stage is disposed above the y-axis stage.

10. The positioning system of claim 1, wherein the chuck is disposed above and coupled to the y-axis carriage.

11. The positioning system of claim 10, wherein the chuck is configured to at least one of translate or rotate relative to the y-axis carriage.

12. The positioning system of claim 10, wherein the y-axis carriage is larger than the x-axis carriage.

13. The positioning system of claim 1, further comprising one or more x-axis encoders and one or more y-axis encoders, wherein the one or more x-axis encoders and the one or more y-axis encoders are configured to sense an x-axis position and a y-axis position, respectively, of the x/y-axis stage.

14. The positioning system of claim 1, wherein the chuck is configured to hold a sample.

15. The positioning system of claim 1, wherein the x/y-axis stage comprises one or more bearings, wherein the one or more bearings couple between the x/y-axis stage and the base.

16. The positioning system of claim 15, wherein the one or more bearings comprise an air bearing.

17. A processing system comprising:
a positioning system comprising:
a base;
a pair of x-axis linear motors;
a pair of y-axis linear motors, wherein the pair of y-axis linear motors are perpendicular to the pair of x-axis linear motors;
an x-axis stage, wherein the pair of x-axis linear motors are coupled between the x-axis stage and the base, wherein the pair of x-axis linear motors are coupled to opposing ends of the x-axis stage by which the x-axis stage is configured to translate along an x-axis;
a y-axis stage, wherein the pair of y-axis linear motors are coupled between the y-axis stage and the base, wherein the pair of y-axis linear motors are coupled to opposing ends of the y-axis stage by which the y-axis stage is configured to translate along a y-axis, wherein the x-axis stage and the y-axis stage are piled; and
an x/y-axis stage, wherein the x/y-axis stage is coupled in parallel with the x-axis stage and the y-axis stage, wherein the x/y-axis stage is configured to follow translation of the x-axis stage along the x-axis and translation of the y-axis stage along the y-axis, wherein the x/y-axis stage comprises:
an x-axis carriage;
a y-axis carriage, wherein the x-axis carriage and the y-axis carriage couple the x/y-axis stage to the x-axis stage and the y-axis stage, respectively; and
a chuck, wherein the chuck is configured to hold a sample; and
a processing head, wherein the positioning system is configured to x/y-axis scan the chuck with the sample under the processing head.

18. The processing system of claim 17, wherein the processing head is configured to direct a beam at the sample.

19. The processing system of claim 17, further comprising a controller, wherein the controller is communicatively coupled with the positioning system, wherein the controller is configured to cause the positioning system to x/y-axis scan the chuck with the sample under the processing head.

20. The processing system of claim 19, wherein the controller is communicatively coupled with the processing head, wherein the controller is configured to receive one or more signals from the processing head, wherein the controller is configured to process the one or more signals to perform at least one of inspection or metrology of the sample.

21. The processing system of claim 17, wherein the chuck with the sample is x/y-axis scanned by translating the x-axis stage and the x/y-axis stage along the x-axis via the pair of x-axis linear motors and by translating the y-axis stage and the x/y-axis stage along the y-axis via the pair of y-axis linear motors.

22. A method comprising:
holding a sample by a chuck of an x/y-axis stage of a positioning system, wherein the positioning system comprises:
a base;
a pair of x-axis linear motors;
a pair of y-axis linear motors, wherein the pair of y-axis linear motors are perpendicular to the pair of x-axis linear motors;
an x-axis stage, wherein the pair of x-axis linear motors are coupled between the x-axis stage and the base, wherein the pair of x-axis linear motors are coupled to opposing ends of the x-axis stage by which the x-axis stage is configured to translate along an x-axis;
a y-axis stage, wherein the pair of y-axis linear motors are coupled between the y-axis stage and the base, wherein the pair of y-axis linear motors are coupled to opposing ends of the y-axis stage by which the y-axis stage is configured to translate along a y-axis, wherein the x-axis stage and the y-axis stage are piled; and
the x/y-axis stage, wherein the x/y-axis stage is coupled in parallel with the x-axis stage and the y-axis stage, wherein the x/y-axis stage is configured to follow translation of the x-axis stage along the x-axis and translation of the y-axis stage along the y-axis, wherein the x/y-axis stage comprises:
an x-axis carriage;
a y-axis carriage, wherein the x-axis carriage and the y-axis carriage couple the x/y-axis stage to the x-axis stage and the y-axis stage, respectively; and
the chuck; and
x/y-axis scanning the chuck with the sample under a processing head.
